(19) United States
(12) Patent Application Publication
(10) Pub. No.: US 2023/0022275 A1
(43) Pub. Date: Jan. 26, 2023

(54) ADDITIVE MANUFACTURING OF METALENSES

(71) Applicant: ams Sensors Singapore Pte. Ltd., Singapore (SG)

(72) Inventor: Nicola Spring, Eindhoven (NL)

(73) Assignee: ams Sensors Singapore Pte. Ltd., Singapore (SG)

(21) Appl. No.: 17/778,377

(22) PCT Filed: Dec. 18, 2020
(86) PCT No.: PCT/SG2020/050761

§ 371 Date: May 19, 2022

Related U.S. Application Data
(60) Provisional application No. 62/952,939, filed on Dec. 23, 2019.

(51) Int. Cl. G02B 1/00; B33Y 10/00; B33Y 80/00

(52) U.S. Cl. CPC G02B 1/002; B33Y 10/00; B33Y 80/00

(57) ABSTRACT

A method of manufacturing an optical element is disclosed. The method comprises the steps of forming a layer of first material on a substrate, forming a plurality of cavities in the layer of first material by an imprinting process, and forming a layer of second material in the plurality of cavities to form an optical meta-surface. Also disclosed is an optical element manufactured according to the method, and an optical device comprising the optical element, and an optical apparatus such as a cellular telephone, a camera, an image-recording device, or a video recording device.

### FIELD OF DISCLOSURE

The present disclosure relates to a method of manufacture of an optical element, in particular wherein the optical element is a metalens for use in an optical device.

### BACKGROUND

Conventional optical lenses, such as convex, concave or meniscus refractive lenses, may be bulky, expensive, and require sophisticated processes to manufacture. Furthermore, the optical capabilities of such lenses at affecting incident radiation may be limited.

In contrast to such conventional lenses, use of optical elements comprising meta-surfaces is becoming increasingly prevalent in optical systems.

A meta-surface generally comprises a plurality of nanostructures, e.g. structures with nanometer scale dimensions in the region of tens or hundreds of nanometers. Such nanostructures are typically arranged in specific patterns to have a defined effect upon incident radiation. That is, specific nanostructure patterns and/or nanostructure dimensions forming the meta-surface may be defined to alter characteristics of incident radiation. A meta-surface designed to alter incident radiation typically comprises nanostructures with dimensions in the region of, or smaller than, a wavelength of the incident radiation.

A meta-surface based flat lens is known in the art as a ‘metalens’. A metalens may be configured, for example, to operate as a convex lens, a concave lens, a prism, or be configured to alter a phase of incident radiation, or the like.

Fabrication of metalenses can be technically challenging due to the particularly small dimensions of nanostructures used to form the meta-surface. That is, due to the small dimensions of the nanostructures, metalenses formed by conventional lithographical techniques may be susceptible to manufacturing defects, potentially resulting in optical aberrations and/or undesired or unpredictable optical characteristics in use.

Furthermore, limitations of present lithographic techniques using the particular materials required to form metalenses may effectively limit practical minimum dimensions and/or geometries of the nanostructures of the metalens.

It is therefore an aim of at least one embodiment of at least one aspect of the present disclosure to obviate or at least mitigate at least one of the above identified shortcomings of the prior art.

### SUMMARY

The present disclosure relates to a method of manufacture of an optical element, in particular wherein the optical element is a metalens for use in an optical device. The present disclosure also more generally relates to an optical device and an apparatus comprising the optical device, such as a cellular telephone, a camera, an image-recording device; and/or a video recording device.

According to a first aspect of the disclosure, there is provided a method of manufacturing an optical element, the method comprising the steps of: forming a layer of first material on a substrate; forming a plurality of cavities in the layer of first material by an imprinting process; and forming a layer of second material in the plurality of cavities to form an optical meta-surface.

Advantageously, manufacturing an optical element by imprinting the layer of first material to form a plurality of cavities may result in structures forming the optical meta-surface with extremely well defined sidewalls. That is, the sidewalls of any columns, pillars, ridges, fins and/or mesas formed from the layer of second material in the plurality of cavities may, for example, be at or substantially close to 90 degrees relative to a surface of the substrate. That is, the sidewalls of any such structures may be substantially vertically oriented relative to a horizontal plane of an upper surface of the substrate.

Furthermore, by adhering to such a method, any such structures may be formed without requiring a step of etching, e.g. wet etching or plasma etching, which may otherwise result in structures without well-defined sidewalls, e.g. because of non-perfect anisotropic etching, or the like.

In a particular embodiment, the second material may comprise a refractive index greater than a refractive index of the substrate. For example, a refractive index of the second material may be greater than a refractive index of the substrate by 0.5, 1.0 or more.

In a particular embodiment, the second material may comprise a refractive index greater less a refractive index of the substrate. For example, a refractive index of the second material may be less than a refractive index of the substrate by 0.5, 1.0 or more.

In a particular embodiment, the second material may comprise a refractive index greater than 1.5. In a particular embodiment, the second material may comprise a refractive index greater than 2. The second material may comprise a refractive index greater than 2.5. The second material may comprise a refractive index between 2 to 3.5.

The imprinting process may comprise directly imprinting the plurality of cavities into the layer of first material.

The imprinting process may comprise imprinting a pattern corresponding to the plurality of cavities into a mask layer. The mask layer may be formed on the layer of first material. The method may comprise subsequently etching the layer of first material to form the plurality of cavities.

The step of forming the layer of second material may comprise selectively growing the second material.

The step of forming the layer of second material may comprise selectively depositing the second material.

Advantageously, the process of imprinting may work synergistically with a process of selective growth/deposition to form structures in the cavities with extremely well-defined sidewalls.

The method may comprise a subsequent step of removing the layer of first material from the substrate such that the layer of second material defines a plurality of columns, pillars, ridges, fins and/or mesas extending from the substrate.

The step of forming the layer of second material may comprise application of a coating to the layer of first material.

The layer of second material may form a substantially planar surface over the layer of first material and the plurality of cavities.

The layer of second material may form a layer of substantially uniform thickness over the layer of first material.

The layer of second material may form a layer conforming to a profile of the cavities in the layer of first material.

The method may comprise a subsequent step of forming a layer of a third material over the layer of the second material.

The third material may comprise a refractive index different from the second material.

The layer of a third material may conform to a profile of the layer of the second material.

The second material may comprise a refractive index greater than the refractive index of the first material.

The cavities may be formed in a substantially concentric arrangement.

The plurality of cavities may be arranged in a pattern of substantially concentric groups.

The layer of second material may comprise a thickness of less than 100nm.

The plurality of cavities may be are arranged with less than 500nm separations.

The plurality of cavities may comprise varying orientations in a plane defined by the substrate.

The method may comprise a preceding step of forming a seed layer on the substrate.

The seed layer may comprise the second material.

The step of forming the layer of second material may comprise at least one of:

atomic layer deposition; chemical vapor deposition; physical vapor deposition; and/or epitaxial growth.

The first and/or second and/or third material may comprise at least one of: gallium nitride, silicon nitride, or a titanium oxide.

According to a second aspect of the disclosure, there is provided an optical element manufactured according to the method of the first aspect.

The optical element may comprise or be configured as a metalens.

The optical element may be configured for operation in at least a portion of a visible light range.

The optical element may be configured for operation in at least a portion of a near infrared range, e.g. for operation with radiation comprising wavelengths of between approximately 0.75 and 1.4 micrometers.

The optical element may be configured for operation in at least a portion of: a short-wavelength infrared range; a mid-wavelength infrared range; a long-wavelength infrared range; and/or a far infrared range.According to a third aspect of the disclosure, there is provided an optical device comprising at least one optical element according the second aspect. The at least one optical device may further comprise a radiation sensor and/or a radiation source. The at least one optical element may be configured for use with the radiation sensor and/or the radiation source.

The at least one optical element may be configured to at least one of: alter a phase of incident radiation; filter incident radiation; focus incident radiation; disperse incident radiation.

The optical device may comprise a plurality of optical elements. The plurality of optical elements may comprise optical elements comprising different configurations.

That is, at least one of the plurality of optical elements may be configured differently from at least one other of the plurality of optical elements.

According to a fourth aspect of the disclosure, there is provided an apparatus comprising an optical device according to the third aspect. The apparatus may comprise at least one of: a cellular telephone, a camera, an image-recording device; and/or a video recording device.

The above summary is intended to be merely exemplary and non-limiting. The disclosure includes one or more corresponding aspects, embodiments or features in isolation or in various combinations whether or not specifically stated (including claimed) in that combination or in isolation. It should be understood that features defined above in accordance with any aspect of the present disclosure or below relating to any specific embodiment of the disclosure may be utilized, either alone or in combination with any other defined feature, in any other aspect or embodiment or to form a further aspect or embodiment of the disclosure.

### BRIEF DESCRIPTION OF DRAWINGS

These and other aspects of the present disclosure will now be described, by way of example only, with reference to the accompanying drawings, which show:

FIGS. 1a-d a method of forming an optical element according to a first embodiment of the disclosure;

FIGS. 2a-c a method of forming an optical element according to a second embodiment of the disclosure;

FIGS. 3a-d a method of forming an optical element according to a third embodiment of the disclosure;

FIGS. 4a-g a method of forming an optical element according to a fourth embodiment of the disclosure;

FIGS. 5a-c a method of forming an optical element according to a fifth embodiment of the disclosure;

FIG. 6 a method of forming an optical element according to a sixth embodiment of the disclosure;

FIG. 7a-d optical devices according to embodiments of the disclosure; and

FIG. 8 an apparatus according to an embodiment of the disclosure.

### DETAILED DESCRIPTION OF DRAWINGS

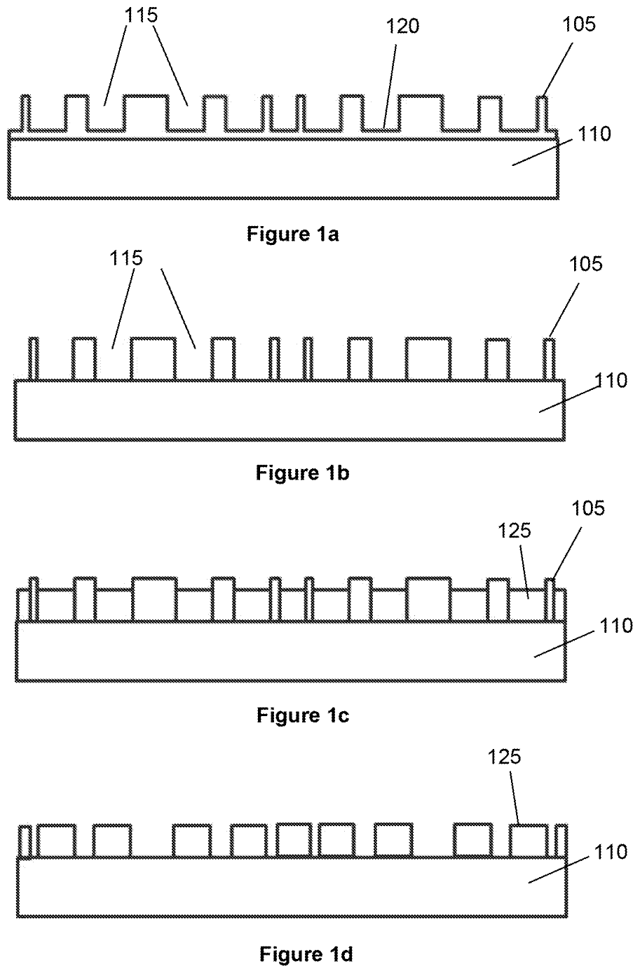

FIGS. 1a to 1d depict a method of manufacturing an optical element according to a first embodiment of the disclosure.

In a first step a layer of first material 105 is formed on a substrate 110. The layer of first material 105 may comprise a curable material. For example, the curable material may be an Ultra Violet (UV) radiation curable material or a thermally curable material.

In an optional preceding step, a seed layer may formed on the substrate 110. The seed layer may be formed, for example, by atomic layer deposition; chemical vapor deposition, physical vapor deposition and/or epitaxial growth. The seed layer may comprise a material suitable for a second material to be formed on, e.g. epitaxially grown on, or the like, wherein the second material is described in more detail below. The seed layer may comprise the second material. In another method, the substrate 110 may be provided as an ‘epi-ready’ substrate e.g. a substrate 110 that has been pre-treated with a seed layer.

In this particular embodiment, the substrate 110 comprises silicon. In another embodiment the substrate 110 may comprise, for example, fused silica, sapphire, or any glass such as a silica-based glass.

The first material may comprise a polymer, e.g. a thermoplastic polymer or the like.

The layer of first material 105 may be formed or deposited on the substrate 110 by spin-coating the substrate 110. In some embodiments, the layer of first material 105 may be deposited, such as by evaporation, onto the substrate 110. In some embodiments, the substrate 110 may be dipped or otherwise submerged in the first material, wherein the first material is in a liquid state, to form the layer of first material 105 on the substrate 110.

The layer of first material 105 may be applied to the substrate 110 in a liquid state. For example, the first material may be heated until the first material transitions to a liquid state, prior to application of the layer of first material 105 to the substrate 110.

The layer of first material 105 may comprise a resist material.

The layer of first material 105 may be formed on a portion of a surface, e.g. an upper surface, of the substrate 110. In some embodiments, the layer of first material 105 may be formed on all, or substantially all, of a surface of the substrate 110.

In a next step also depicted in FIG. 1 a, a plurality of cavities 115 are formed in the layer of first material 105 by an imprinting process.

The plurality of cavities 115 may be formed by directly imprinting the plurality of cavities 115 into the layer of first material 105. For example, the plurality of cavities 115 may be formed by a process of imprinting, e.g. a process of nanoimprint lithography as described in more detail below.

In one example embodiment, the plurality of cavities 115 may be formed by a process of thermoplastic nanoimprint lithography. That is, the layer of first material 105 is coated onto the substrate 110, and then a mold (not shown) comprising a predefined topological pattern is pressed onto the layer of first material 105. The layer of first material 105 is then heated directly and/or heated via the substrate 110 and/or heated via the mold, such that the layer of first material 105 is softened. The topological pattern on the mold is then pressed into the softened layer of first material 105, thus transferring a pattern corresponding to the predefined topological patterns of the mold to the layer of first material 105. As shown in FIG. 1 a, the pattern corresponding to the predefined topological patterns comprises the plurality of cavities 115. After the layer of first material 105 has sufficiently cooled, the mold may be separated from the layer of first material 105.

In another example embodiment, the plurality of cavities 115 are formed by a process of photo-nanoimprint lithography. That is, the layer of first material 105 is coated onto the substrate 110, wherein the layer of first material 105 comprises a photo-curable material. At this stage, the layer of first material 105 may be in a substantially malleable, softened, or liquid state. Then, the mold comprising the predefined topological patterns is pressed onto the layer of first material 105. The layer of first material is subsequently cured by exposure to radiation, such as Ultra Violet (UV) radiation. The mold may, for example, be transparent to radiation at wavelengths suitable for curing the layer of first material 105. After curing of the first material, the mold may be separated from the layer of first material 105.

As shown in FIG. 1a, a residual layer 120, or scum, comprising first material may reside in at least one of the plurality of cavities 115.

In an example embodiment, the residual layer 120 may be removed from the substrate 110 by a plasma descum process, such as a descum process employing an oxygen plasma or a high power argon plasma. As a result of the descum process, portions of the substrate 110 corresponding to the plurality of cavities 115 will be exposed, as shown in FIG. 1b. That is, portions of an upper surface of the substrate 110 will be exposed, as shown in FIG. 1b.

The plurality of cavities 115 may be formed in a defined arrangement, e.g. with defined geometries and orientations, such that a resultant meta-surface formed from the cavities (as described in more detail below with respect for Figures lc and 1d) may have a desired effect upon incident radiation. For example, in one embodiment, the plurality of cavities 115 may be provided in a substantially concentric arrangement and/or the plurality of cavities 115 may be arranged in a pattern of substantially concentric groups.

In one example embodiment, the plurality of cavities 115 may be arranged with less than 1 micrometer separations. In another embodiment, the plurality of cavities 115 may be arranged with less than 500 nanometer separations. In one example embodiment, the layer of first material 105 may have a thickness of less than 500 nanometers. In another embodiment, the layer of first material 105 may have a thickness of less than 100 nanometers.

In a next step shown in FIG. 1c, a layer of second material 125 is formed in the plurality of cavities 115 to form an optical meta-surface. The second material may comprise a high refractive index. For example, the second material may comprise a refractive index of 2 or more.

In one embodiment, the layer of second material 125 comprises gallium nitride. In other embodiments, the layer of second material 125 may, for example, comprise silicon, silicon dioxide, silicon nitride, titanium oxide, or the like.

The first and/or second material may be transparent, or substantially transparent to radiation with wavelengths in a visible light range and/or a near infrared range, e.g. approximately 380 to 740 nanometers. Additionally and/or alternatively, the first and/or second material may be transparent, or substantially transparent to radiation with wavelengths in the UV, near infrared, short, mid or long wavelength infrared, or far infrared range. In a particular embodiment, dimensions of the plurality of cavities 115, e.g. lateral and/or vertical dimensions and/or spacing between cavities may be smaller than a wavelength of radiation to which the first and/or second material is transparent.

In one embodiment, the layer of second material 125 is formed by a process of selective growth. As shown in FIG. 1c, the process of selective growth ensures the layer of second material 125 is formed on the exposed portions of the substrate 110, but is generally not formed on remaining portions of the layer of first material 105.

The process of selective growth of the layer of second material 125 may comprise a process of selective chemical vapor deposition. In other embodiments, other deposition processes may be used. For example, the process of selective growth of the layer of second material 125 may alternatively, or additionally, comprise a process of physical vapor deposition and/or epitaxial growth.

In a further optional step shown in FIG. 1d, the layer of first material 105 may be stripped away, e.g. chemically stripped away or the like, thus exposing portions of the substrate 110. That is, in the example embodiment of FIG. 1d, the layer of first material 105 is removed from the substrate 110 such that the layer of second material 125 defines a plurality of columns, pillars, ridges, fins and/or mesas extending from the substrate 110.

Advantageously, the process of imprinting the layer of first material 105 to form a plurality of cavities 115, together with a subsequent selective growth of a layer of second material 125 in the plurality of cavities 115 results in a plurality of columns, pillars, ridges, fins and/or mesas extending from the substrate 110 with extremely well-defined sidewalls. That is, the sidewalls of any columns, pillars, ridges, fins and/or mesas may for example be at, or close to, substantially 90 degrees relative to a surface of the substrate 110. That is, the sidewalls of any columns, pillars, ridges, fins and/or mesas may be substantially vertically oriented relative to a horizontal plane of an upper surface of the substrate 110.

Beneficially, by adhering to the method described with respect to and/or depicted in FIGS. 1a to 1d, the columns, pillars, ridges, fins and/or mesas are formed without using a process of etching, e.g. wet etching or plasma etching, which may have otherwise resulted in columns, pillars, ridges, fins and/or mesas without well-defined sidewalls, e.g. a non-perfect anisotropic etch.

In yet further embodiments (not shown) additional coatings or layers may be subsequently deposited over the layer of second material 125, wherein the additional coatings and/or layers may comprise a refractive index that is substantially different from the refractive index of the second material.

The optical element depicted in FIG. 1d is a metalens.

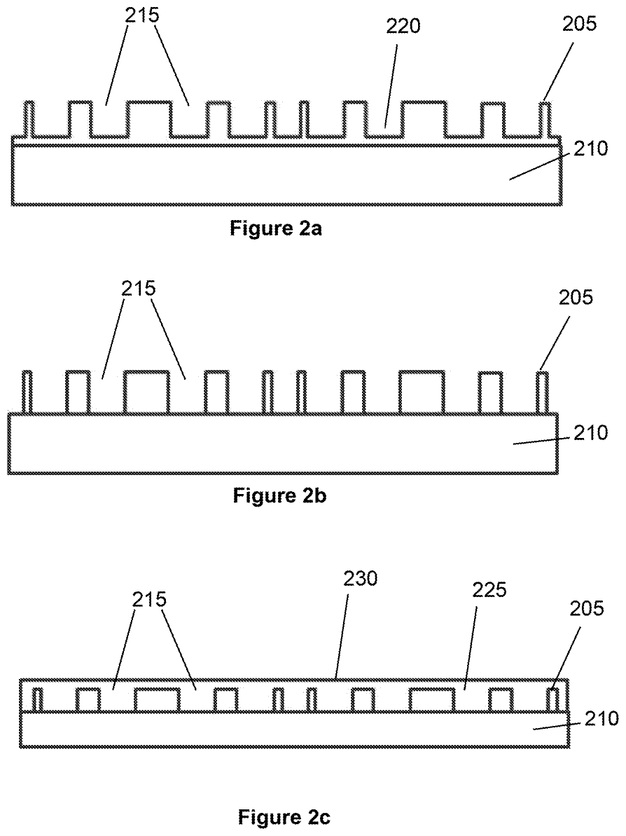

FIGS. 2a to 2c depict a second embodiment of a method of manufacturing an optical element according to the disclosure.

In a first step a layer of first material 205 is formed on a substrate 210. The layer of first material 205 may comprise a curable material. For example, the curable material may be an Ultra Violet (UV) radiation curable material or a thermally curable material.

In a next step also depicted in FIG. 2a, a plurality of cavities 215 are formed in the layer of first material 205 by an imprinting process.

In a next step, a residual layer 220 may be removed from the substrate 210, for example by a process of plasma descum or the like.

The steps shown in FIGS. 2a and 2b correspond to the steps of the embodiment already described with reference to FIGS. 1a and 1b, and therefore are not described in further detail for purposes of brevity. The imprinting process for forming the plurality of cavities 215 may be, for example, a process of thermoplastic nanoimprint lithography or photo-nanoimprint lithography, as already described above.

In a next step shown in FIG. 2c, a layer of second material 225 is formed in the plurality of cavities 215 to form an optical meta-surface. In this particular embodiment, the layer of second material 225 is applied as a coating to the layer of first material 205. As shown in FIG. 2c, the layer of second material 225 may form a substantially planar surface 230 over the layer of first material 205 and the plurality of cavities 215.

In some embodiments, the second material has a substantially different refractive index than the refractive index of the first material. For example, in a one embodiment the second material may have a refractive index that differs from a refractive index of the first material by at least 1. In some embodiments, the second material may have a refractive index that differs from a refractive index of the first material by 1.5, 2, 2.5 or more.

The layer of second material 225 may be at least partially formed by, for example, atomic layer deposition, chemical vapor deposition, physical vapor deposition and/or epitaxial growth. Additionally and/or alternatively, the layer of second material 225 may be at least partially formed by spin-coating the layer of second material 225 onto the layer of first material 205.

In contrast to the embodiment described with respect to FIGS. 1a to 1d, the layer of second material 225 is not selectively grown and as such, the layer of second material 225 is formed on both the layer of first material 205 and in the plurality of cavities 215 formed in the layer of first material 205, e.g. on exposed portions of the substrate 210.

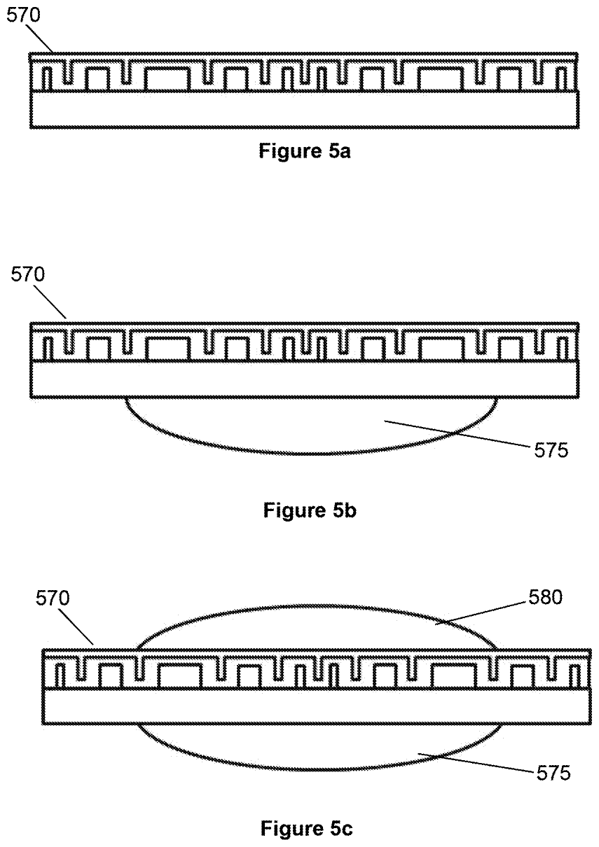

The planar surface 230 may be particularly suited to mounting of further optical components, as will be described in more detail with reference to FIG. 5b.

The optical element depicted in FIG. 2c is a metalens.

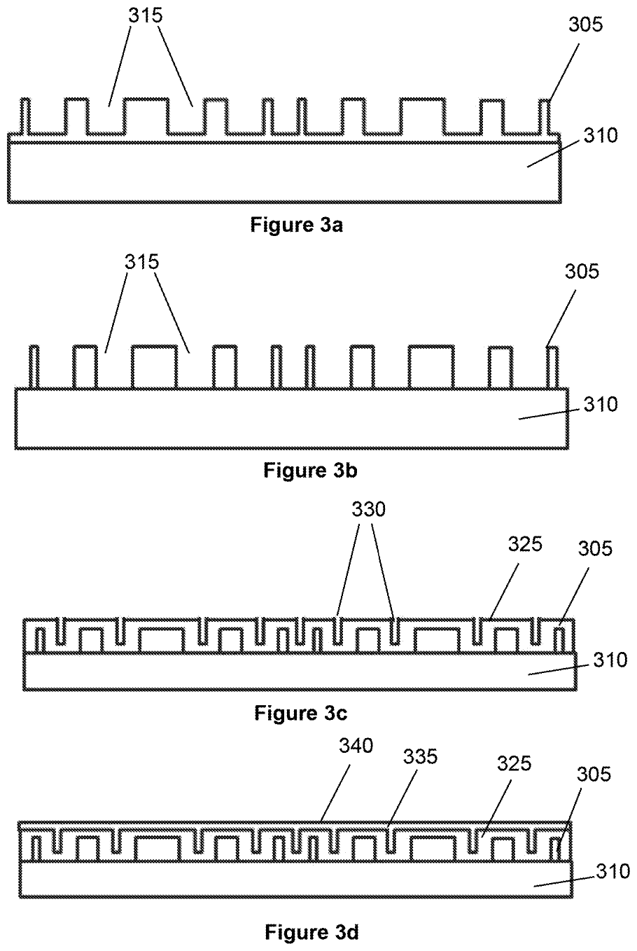

FIGS. 3a to 3d depict a further embodiment of a method of manufacturing an optical element according to an embodiment of the disclosure.

The steps shown in FIGS. 3a and 3b correspond to the steps of the embodiment already described with reference to FIGS. 1a and 1b, and therefore are not described in further detail. The imprinting process for forming a plurality of cavities 315 in a layer of first material 305 on a substrate 310 may be, for example, a process of thermoplastic nanoimprint lithography or photo-nanoimprint lithography, as already described above.

In a next step shown in FIG. 3c, a layer of second material 325 is formed in the plurality of cavities 315 to form an optical meta-surface. In this particular embodiment, the layer of second material 325 is applied as a conformal coating to the layer of first material 305. That is, the layer of second material 325 conforms to a profile, e.g. a geometric and/or topographic profile, of an underlying layer of first material 305.

The layer of second material 325 may be formed by, for example, atomic layer deposition, chemical vapor deposition, physical vapor deposition and/or epitaxial growth. Again, in contrast to the embodiment described with respect to FIGS. 1a to 1d, the layer of second material 325 is not selectively grown and as such, the layer of second material 325 is formed on both the layer of first material 305 and in the plurality of cavities 315 formed in the layer of first material 205, e.g. on exposed portions of substrate 310.

In one embodiment, the layer of second material 325 may be substantially uniformly formed on the both the layer of first material 305 and in the plurality of cavities 315 formed in the layer of first material 305. That is, the layer of second material 325 may comprise a substantially uniform thickness.

The layer of second material 325 may comprise a plurality of cavities 330 corresponding to the plurality of cavities 315 in the layer of first material 325. That is, due to the layer of second material substantially conforming to the geometric profile of the layer of first material 325, the layer of second material 325 comprises cavities, as shown in FIG. 3c.

In an optional additional step, a layer of third material 335 may be formed over the layer of the second material 325, as shown in FIG. 3d. The layer of third material 325 may be formed by, for example, any of spin-coating, atomic layer deposition, chemical vapor deposition; physical vapor deposition; and/or epitaxial growth. The layer of third material 335 may fill the plurality of cavities 330 in the layer of second material 325. The layer of third material 335 may form a substantially planar surface 340 over the layer of second material 325 and the plurality of cavities 330.

The third material may be selected to comprise a refractive index different from the second and/or first material. For example, in some embodiments, the third material may have a refractive index that differs from a refractive index of the second and/or first material by 1, or more.

The planar surface 340 may be particularly suited to mounting of further optical components, as will be described in more detail with reference to FIG. 5c.

The optical element depicted in FIG. 3d is a metalens.

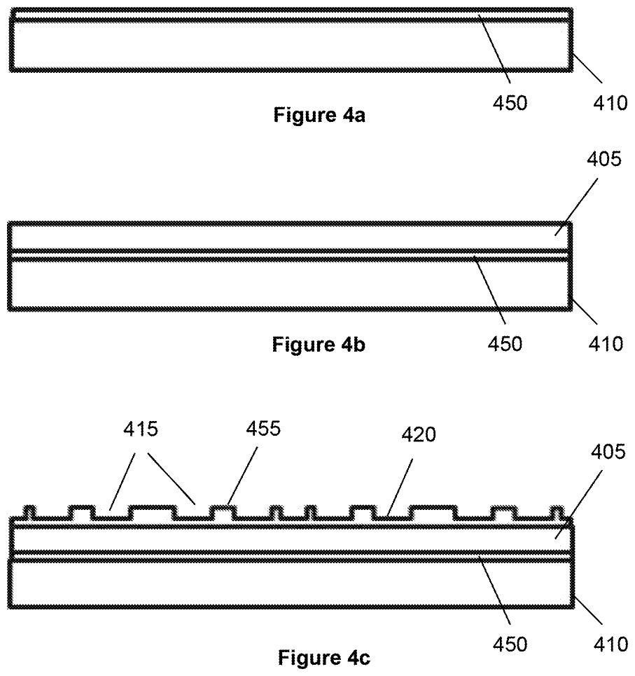

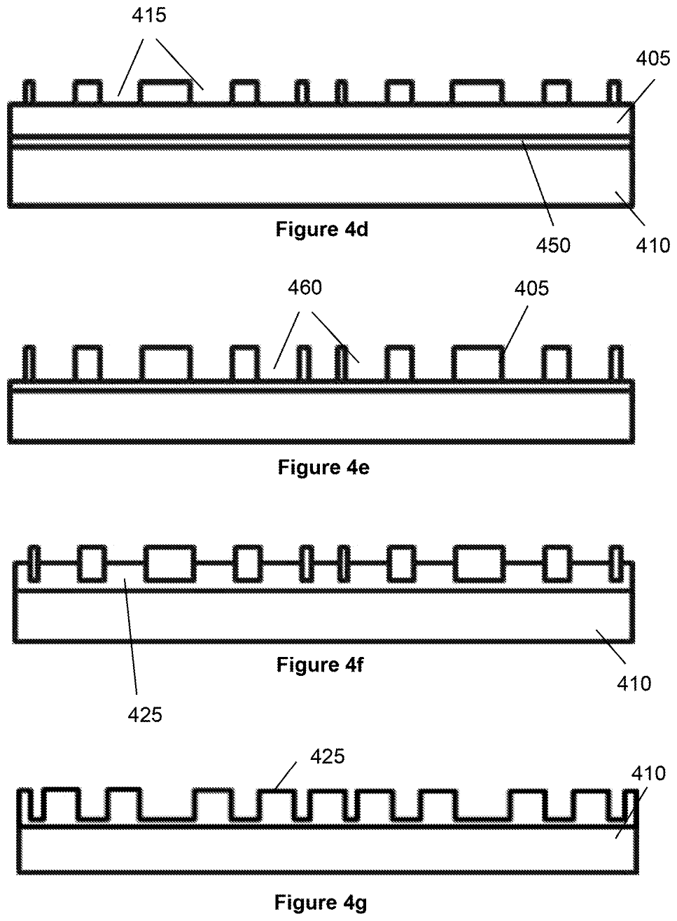

FIGS. 4a to 4g depict a method of manufacturing an optical element according to a further embodiment of the disclosure.

In an optional first step depicted in FIG. 4a, a seed layer 450 is formed on a substrate 410. The seed layer 450 may be formed, for example, by atomic layer deposition, chemical vapor deposition, physical vapor deposition and/or epitaxial growth. The seed layer 450 may comprise a material suitable for a second material to be formed on, e.g. epitaxially grown on, or the like, wherein the second material is described in more detail below. The seed layer 450 may comprise the second material. In a particular method, the substrate may be provide as an ‘epi-ready’ substrate e.g. a substrate that has been pre-treated with a seed layer.

In a next step depicted in FIG. 4b, a layer of first material 405 is formed on a substrate 410. In the example embodiment of depicted in FIG. 4b, the layer of first material 405 is formed on the seed layer 450, which may optionally be present as described above. The layer of first material 405 may comprise, for example, silicon and/or silicon dioxide. In other embodiments, the first material may comprise gallium nitride, silicon nitride, titanium oxide, or the like.

As depicted in FIG. 4c, a mask layer 455 may be formed on the layer of first material 405. The mask layer 455 may comprise a polymer, e.g. a thermoplastic polymer or the like.

The layer of first material 405 may be formed or deposited on the substrate 410 (or seed layer 450) by spin-coating the substrate 410. In some embodiments, the layer of first material 405 may be deposited, such as by evaporation, on the substrate 410 (or seed layer 450), for example by atomic layer deposition, chemical vapor deposition, physical vapor deposition and/or epitaxial growth.

The mask layer 455 may be formed or deposited on the layer of first material 405 by spin-coating the layer of first material 405. Alternatively, the mask layer 455 may be deposited on the layer of first material 405, for example by atomic layer deposition, chemical vapor deposition, physical vapor deposition and/or epitaxial growth.

As depicted in FIG. 4c, a plurality of cavities 415 may be formed in the mask layer 455 by an imprinting process. The imprinting process may, for example, be a process of thermoplastic nanoimprint lithography or a process of photo-nanoimprint lithography. Such processes have already been described above with respect to FIG. 1a, and will not be detailed further at this juncture.

As depicted in FIG. 4d, a residual layer 420, e.g. a residual layer 420 or scum of the mask layer 455, may be removed from the layer of first material 405 by a plasma descum process, such as a descum process employing an oxygen plasma or a high power argon plasma, or the like. As a result of the descum process, portions of the layer of first material 405 corresponding to the plurality of cavities 415 will be exposed, as shown in FIG. 4d. That is, portions of an upper surface of the layer of first material 405 will be exposed, as shown in FIG. 4d.

In subsequent steps depicted in FIG. 4e, a process of etching, e.g. wet-etching or plasma etching, may be used to etch a plurality of cavities 460 into the layer of first material 405, wherein the plurality of cavities 460 is defined by the plurality of cavities 415 formed in the mask layer 455. The mask layer 455 may then be stripped away, e.g. chemically stripped, resulting in the structure as depicted in FIG. 4e. If necessary, a further descum process may also be carried out to remove any residual layer or scum (not shown) comprising first material that may reside in at least one of the plurality of cavities 460.

The remaining steps of selective growth of a layer of second material 425 as depicted in FIG. 4f and an optional step of stripping of the layer of first material 405 depicted in FIG. 4g substantially correspond to the steps described with relation to FIGS. 1c and 1d, and will not be detailed further for purposes of brevity. It will also be appreciated that in another embodiment a coating may be applied to the structure shown in FIG. 4e, as previously described with reference to FIG. 2c. Similarly, it will also be appreciated that, in yet another alternative embodiment, a conformal coating may be applied to the structure shown in FIG. 4e, as previously described with reference to FIGS. 3c and 3d.

The optical element depicted in FIG. 4g is a metalens. FIGS. 5a to 5c depict a method of forming an optical device according to an embodiment of the disclosure. FIG. 5a depicts an optical element 570. For purposes of example only, the optical element 570 corresponds to the metalens formed by the process outlined in FIGS. 3a to 3d. It will be appreciated that in other embodiments, a different metalens such as that described with reference to and/or depicted in any of FIG. 1d, 2c or 4g may alternatively, or additionally, be used.

The optical element 570 may be coupled to and/or combined with a further optical component 575, as shown in FIG. 5b. In the example embodiment shown in FIG. 5b, the further optical component 575 is a lens. The further optical component 575 has been adhered, or otherwise coupled to, a lower surface of the optical element 570. It will be appreciated that in other embodiments the further optical component 575 may be adhered, or otherwise coupled to, a lower surface of the optical element 570.

The further optical component 575 may for example be a Micro-Lens Array (MLA), a diffuser, a Diffractive Optical Element (DOE), a Fresnel lens, a refractive lens, or the like.

In a further example embodiment shown in FIG. 5c, the optical element 570 may be coupled to and/or combined with a plurality of further optical components 575, 580. In the example shown the optical element 570 is combined with a lower optical component 575 adhered, or otherwise coupled to, a lower surface of the optical element 570 and an upper optical component 580 adhered, or otherwise coupled to, an upper surface of the optical element 570.

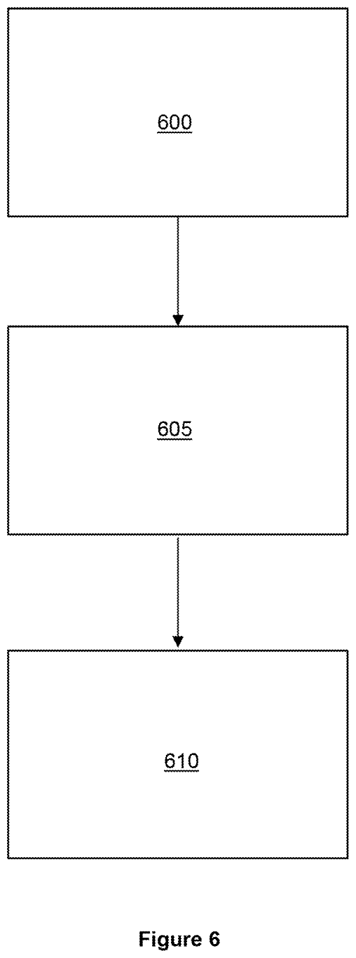

FIG. 6 depicts a flow diagram corresponding to a method of manufacturing an optical element. A first step 600, comprises forming a layer of first material on a substrate. A subsequent step 605 comprises forming a plurality of cavities in the layer of first material by an imprinting process. A subsequent step 610 comprises forming a layer of second material in the plurality of cavities to form an optical meta-surface.

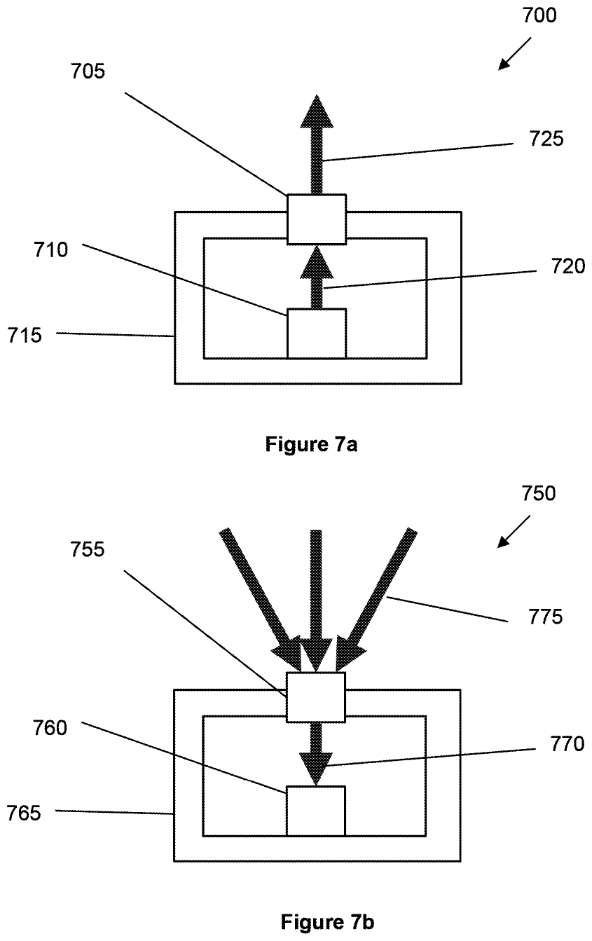

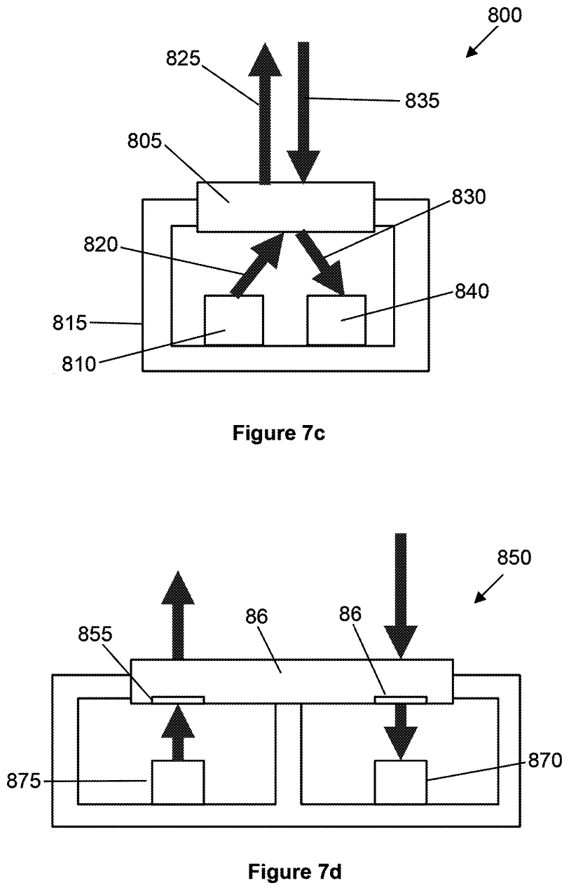

FIG. 7a depicts an optical device, generally denoted 700, according to an embodiment of the disclosure. The optical device 700 comprises an optical element 705. The optical element 705 may be, for example, an optical element as described with reference to any of FIG. 1d, 2c, 3d, 4g, 5a, 6b, 5a, 5b or 5c.

The example optical device 700 comprises a radiation source 710. The radiation source 710 may comprise a light emitting diode.

The radiation source 710 and the optical element 705 are supported by a supporting member 715. It will be appreciated that in other embodiments, the supporting member 715 may have a different configuration. For example, the supporting member 715 may comprise one or more spacer elements for spacing the radiation source 710 from the optical element 705.

In yet further embodiments, the radiation source 710 and the optical element 705 may be directly coupled, e.g. held immediately adjacent one another by the supporting member 715. In yet further embodiments, the optical device 700 may not comprise a supporting member 715, and instead the radiation source 710 and the optical element 705 may be directly coupled, such as by adhesion or otherwise. In yet further embodiments, the optical element 705 may be formed directly upon the radiation source 710.

The radiation source 710 may be configured to emit radiation 720. In the example embodiment of FIG. 7a, the radiation source 710 is disposed relative to the optical element 705 such that radiation 720 emitted by the radiation source 710 is incident upon the optical element 705.

The optical element 705 may alter the incident radiation 720, resulting in emitted radiation 725 emitted by the optical device 700. For example, the optical element 705 may be configured to alter a phase of incident radiation 720. In other embodiments the optical element 705 may be configured to additionally or alternatively at least one of filter, focus or disperse incident radiation 720.

FIG. 7b depicts an optical device, generally denoted 750, according to a further embodiment of the disclosure. The optical device 750 comprises an optical element 755. The optical element 755 may, for example, be an optical element as described with reference to any of FIGS. 1d, 2c, 3d, 4g, 5a, 5b, 5c.

The example optical device 750 comprises a radiation sensor 760. The radiation sensor 760 may comprise, for example, a photodiode. The radiation sensor 760 may comprise an active pixel sensor. The radiation sensor 760 may comprise an array of sensors.

The radiation sensor 760 and the optical element 765 are supported by a supporting member 765. It will be appreciated that in other embodiments, the supporting member 765 may have a different configuration. For example, the supporting member 765 may comprise one or more spacer elements for spacing the radiation sensor 760 from the optical element 755.

In yet further embodiments, the radiation sensor 760 and the optical element 755 may be directly coupled, e.g. held adjacent one another by the supporting member 765. In yet further embodiments, the optical device 750 may not comprise a supporting member 765, and instead the radiation sensor 760 and the optical element 755 may be directly coupled, such as by adhesion or otherwise. In yet further embodiments, the optical element 755 may be formed directly upon the radiation sensor 760.

The optical element 705 may be configured to alter radiation 725 incident upon the optical element 705. For example, the optical element 705 may be configured to alter radiation 725, such that radiation 770 incident upon the radiation sensor 760 exhibits different characteristics from the radiation 775 incident upon the optical element 705. For example, the optical element 755 may be configured to alter a phase of incident radiation 775. In other embodiments, the optical element 705 may alternatively or additionally be configured to at least one of filter, focus or disperse the incident radiation 775. In a particular embodiment, the optical element 755 may be configured to focus radiation 775 such that a focal point of radiation 770 is incident upon the radiation sensor 760.

FIG. 7c depicts an optical device, generally denoted 800, according to an embodiment of the disclosure. The optical device 800 comprises an optical element 805. The optical element 805 may be, for example, an optical element as described with reference to any of FIG. 1d, 2c, 3d, 4g, 5a, 6b, 5a, 5b or 5c.

The example optical device 800 comprises a radiation source 810. The radiation source 810 may comprise a light emitting diode.

The example optical device 800 comprises a radiation sensor 840. The radiation sensor 840 may comprise, for example, a photodiode. The radiation sensor 840 may comprise an active pixel sensor. The radiation sensor 840 may comprise an array of sensors.

The radiation source 810, the radiation sensor 840, and/or the optical element 805 may be supported by a supporting member 815. It will be appreciated that in other embodiments, the supporting member 815 may have a different configuration. For example, the supporting member 815 may comprise one or more spacer elements for spacing the radiation source 810 and/or the radiation sensor 840 from the optical element 805.

The radiation source 810 may be configured to emit radiation 820. In the example embodiment of FIG. 7c, the radiation source 810 is disposed relative to the optical element 805 such that radiation 820 emitted by the radiation source 810 is incident upon the optical element 805.

The optical element 805 may alter the incident radiation 820, resulting in emitted radiation 825 emitted by the optical device 800. For example, the optical element 805 may be configured to alter a phase of incident radiation 820. In other embodiments the optical element 805 may be configured to additionally or alternatively at least one of filter, focus or disperse incident radiation 820.

Additionally or alternatively, the optical element 805 may reflect at least a portion of the incident radiation. A reflected portion 830 of the incident radiation may be sensed by the radiation sensor 840.

Additionally or alternatively, the optical element 805 may be configured to alter radiation 835 incident upon the optical element 805 from outside the optical device 800. For example, the optical element 805 may be configured to alter radiation 835, such that radiation 830 incident upon the radiation sensor 840 exhibits different characteristics from the radiation 835 incident upon the optical element 805 from outside the optical device 800. For example, the optical element 805 may be configured to alter a phase of incident radiation 835. In other embodiments, the optical element 805 may alternatively or additionally be configured to at least one of filter, focus or disperse the incident radiation 835. In a particular embodiment, the optical element 805 may be configured to focus radiation 835 such that a focal point of radiation 830 is incident upon the radiation sensor 840.

FIG. 7d depicts an optical device, generally denoted 850, according to a further embodiment of the disclosure. The optical device 850 comprises a first optical element 855 and a second optical element 860 formed on a common substrate 865. The first optical element 855 and the second optical element 860 may, for example, be optical elements as described with reference to any of FIGS. 1d, 2c, 3d, 4g, 5a, 5b, 5c.

That is, in embodiments of the disclosure, a plurality of optical elements may be formed on a common substrate, by forming a plurality of optical meta-surfaces on the common substrate. The plurality of optical meta-surfaces may comprise one or more optical meta-surfaces with the same characteristics. The plurality of optical meta-surfaces may comprise one or more optical meta-surfaces with the different characteristics.

For purposes of example only, FIG. 7d also comprises a radiation sensor 870 and a radiation source 875, with features and functionality as already described above with reference to FIGS. 7a to 7c.

For purposes of example only, first and second optical elements 855, 860 are depicted as disposed, e.g. formed, on a lower surface of the common substrate 865. It will be appreciated that one or more meta-surfaces may alternatively and/or additionally be disposed, e.g. formed, on an upper surface of the common substrate 865. Similarly, the optical elements 705, 755, 705 depicted in FIGS. 7a, 7b and 7c may comprise meta-surfaces disposed on an upper and/or lower surfaces of the optical elements 705, 755, 805.

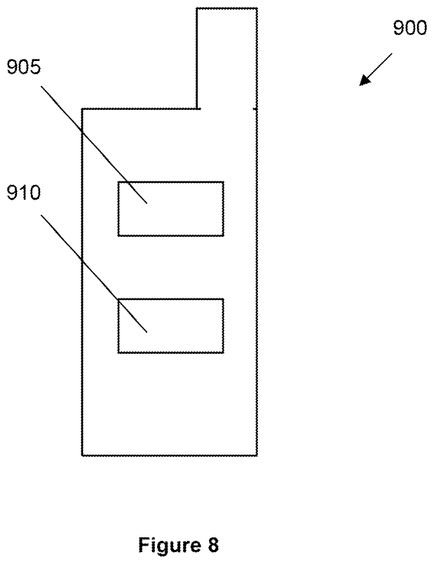

FIG. 8 depicts an apparatus, generally denoted 900, comprising an optical device 905. The optical device 905 may, for example, be an optical device 700, 750, 800, 850 as described with reference to FIGS. 7a to 7d.

The optical device 905 is communicably coupled to processor circuitry 910. The processor circuitry 910 is configured to receive a signal from the optical device 905 and/or provide a signal and/or power to the optical device 905. The apparatus 900 is, for purposes of example only, a cellular phone. It will be appreciated that, in other examples, the apparatus 900 may be a digital camera, a security camera, a laptop or tablet device, an image recording device, or the like.

The applicant discloses in isolation each individual feature described herein and any combination of two or more such features, to the extent that such features or combinations are capable of being carried out based on the specification as a whole in the light of the common general knowledge of a person skilled in the art, irrespective of whether such features or combinations of features solve any problems disclosed herein, and without limitation to the scope of the claims. The applicant indicates that aspects of the disclosure may consist of any such individual feature or combination of features. In view of the foregoing description it will be evident to a person skilled in the art that various modifications may be made within the scope of the disclosure.

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of particular embodiments as set forth above, it should be understood that these embodiments are illustrative only and that the claims are not limited to those embodiments. Those skilled in the art will be able to make modifications and alternatives in view of the disclosure, which are contemplated as falling within the scope of the appended claims. Each feature disclosed or illustrated in the present specification may be incorporated in any embodiments, whether alone or in any appropriate combination with any other feature disclosed or illustrated herein.

LIST OF REFERENCE NUMERALS

| | | | | |
|---|---|---|---|---|
| 105 | layer of first material | | 450 | seed layer |
| 110 | substrate | | 455 | mask layer |
| 115 | plurality of cavities | | 460 | plurality of cavities |
| 120 | residual layer | | 570 | optical element |
| 125 | layer of second material | 40 | 575 | optical component |
| 205 | layer of first material | | 580 | optical component |
| 210 | substrate | | 600 | first step |
| 215 | plurality of cavities | | 605 | subsequent step |
| 220 | residual layer | | 610 | subsequent step |
| 225 | layer of second material | 45 | 700 | optical device |
| 230 | planar surface | | 705 | optical element |
| 305 | layer of first material | | 710 | radiation source |
| 310 | substrate | | 715 | supporting member |
| 315 | plurality of cavities | | 720 | radiation |
| 325 | layer of second material | 50 | 725 | radiation |
| 330 | plurality of cavities | | 750 | optical device |
| 335 | layer of third material | | 755 | optical element |
| 340 | planar surface | | 760 | radiation sensor |
| 405 | layer of first material | | 765 | supporting member |
| 410 | substrate | 55 | 770 | radiation |
| 415 | plurality of cavities | | 775 | radiation |
| 420 | residual layer | | 800 | optical device |
| 425 | layer of second material | | 805 | optical element |
| 810 | radiation source | | 855 | first optical element |
| 840 | radiation sensor | 10 | 860 | second optical element |
| 815 | supporting member | | 865 | common substrate |
| 820 | incident radiation | | 870 | radiation sensor |
| 825 | emitted radiation | | 875 | radiation source |
| 830 | reflected portion | | 900 | apparatus |
| 835 | radiation | 15 | 905 | optical device |
| 850 | optical device | | 910 | processor circuitry |

1. A method of manufacturing an optical element, the method comprising the steps of:
forming a layer of first material on a substrate;
forming a plurality of cavities in the layer of first material by an imprinting process; and
forming a layer of second material in the plurality of cavities to form an optical meta-surface.

2. The method of claim 1, wherein the imprinting process comprises:
directly imprinting the plurality of cavities into the layer of first material; or
imprinting a pattern corresponding to the plurality of cavities into a mask layer formed on the layer of first material, and subsequently etching the layer of first material to form the plurality of cavities.

3. The method of claim 1, wherein the step of forming the layer of second material comprises selectively growing or selectively depositing the second material.

4. The method of claim 3 comprising a subsequent step of removing the layer of first material from the substrate such that the layer of second material defines a plurality of columns, pillars, ridges, fins and/or mesas extending from the substrate.

5. The method of claim 1, wherein the step of forming the layer of second material comprises application of a coating to the layer of first material.

6. The method of claim 5, wherein the layer of second material forms:
a substantially planar surface over the layer of first material and the plurality of cavities; and/or
a layer of substantially uniform thickness over the layer of first material; and/or
a layer conforming to a profile of the cavities in the layer of first material.

7. The method of claim 1 comprising a subsequent step of forming a layer of a third material over the layer of the second material, wherein:
the third material has a refractive index different from the second material; and/or
the layer of a third material conforms to a profile of the layer of the second material.

8. The method of claim 1, wherein the second material has a refractive index greater than the refractive index of the first material.

9. The method of claim 1, wherein the second material has a refractive index greater than 2.

10. The method of claim 1 wherein the plurality of cavities are formed in a substantially concentric arrangement and/or the plurality of cavities are arranged in a pattern of substantially concentric groups.

11. The method of claim 1, wherein at least one of:
the layer of second material has a thickness of less than 100 nanometers;
the plurality of cavities are arranged with less than 500 nanometers separations;
the plurality of cavities have varying orientations in a plane defined by the substrate.

12. The method of claim 1, comprising a preceding step of forming a seed layer on the substrate, and optionally wherein the seed layer comprises the second material.

13. The method of claim 1, wherein the step of forming the layer of second material comprises at least one of: atomic layer deposition; chemical vapor deposition; physical vapor deposition; and/or epitaxial growth.

14. The method of claim 1, wherein the first and/or second material comprises gallium nitride, silicon nitride, or a titanium oxide and, when dependent upon claim 8, wherein the third material comprises gallium nitride, silicon nitride, or a titanium oxide.

15. An optical element manufactured according to the method of claim 1.

16. The optical element of claim 15, configured as a metalens.

17. The optical element of claim 15, wherein the optical element is configured for operation in at least a portion of a visible light range and/or a near infrared range.

18. An optical device comprising at least one optical element according to claim 15, the optical device further comprising a radiation sensor and/or a radiation source, wherein the at least one optical element is configured for use with the radiation sensor and/or the radiation source.

19. An apparatus comprising an optical device according to claim 18, wherein the apparatus is at least one of: a cellular telephone, a camera, an image-recording device; and/or a video recording device.
